(19) United States
(12) Patent Application Publication
(10) Pub. No.: US 2012/0256911 A1
(43) Pub. Date: Oct. 11, 2012

(54) IMAGE PROCESSING APPARATUS, IMAGE PROCESSING METHOD, AND PROGRAM

(76) Inventor: Sensaburo Nakamura, Kanagawa (JP)

(21) Appl. No.: 13/432,182

(22) Filed: Mar. 28, 2012

(30) Foreign Application Priority Data
Apr. 6, 2011 (JP) 2011-084435

(51) Int. Cl. G06T 15/04; G09G 5/373; G06T 11/40

(52) U.S. Cl. 345/419; 345/582

(57) ABSTRACT

An image generating unit generates a computer graphics (CG) image based on CG description data. An image mapping unit texture-maps an image to a surface of a polygon rendered by the image, generating unit. When an instruction to turn a cropping process on is given, mapping is performed while performing the cropping process. That is, the image mapping unit performs mapping such that an end portion of an image to be texture-mapped is not included in an output image of the image generating unit. The image mapping unit performs the cropping process when an image is a cropping target.

### BACKGROUND

The present technology relates to an image processing apparatus, an image processing method, and a program. Particularly, the present technology relates to an image, processing apparatus or the like that texture-maps an image to the surface of a computer graphics (CG) object.

In three-dimensional (3D) graphics systems, rendering of an overall image is performed such that 3D coordinates are broken into polygons such as a triangle and then rendering is performed on the polygons. Therefore, in this case, it can be said that a 3D image is defined by a combination of polygons. Meanwhile, many object surfaces around us have repetitive patterns of complicated shapes. As shapes or patterns become more complicated and finer, it is difficult to model each shape or pattern by a triangle or the like. In this regard, texture mapping is used as a means of solving the above problem.

Texture mapping realizes a highly realistic image by a small number of vertices by attaching image data obtained by a scanner or the like to an object surface. Thus, a texture cell element (Texel), which is an element of a texture corresponding to each picture cell element (Pixel) in a window coordinate system, is obtained by defining mapping from an object coordinate system to a texture coordinate system and obtaining mapping from the window coordinate system to the texture coordinate system.

Image data used for the texture is stored in a memory area, called a texture memory. Thus, when the texture memory is regularly updated using moving image data, a texture mapping process based on a moving image can be performed.

For example, Japanese Patent Application Laid-Open No. 2007-013874 discloses an image special effect apparatus that changes an image by texture mapping to an arbitrary shape.

### SUMMARY

In an image (image data), an image may be distorted in an end portion of a screen. For this reason, broadcast video devices of related arts are provided with a cropping function (of cutting off the edge of an image). When there is a problem in the edge of a texture-mapped image in computer graphics (CG) and the edge of the image is desired to be cropped, performing a cropping process on a synthesized CG image is useless. Further, it costs a lot to install a device or a circuit that performs image enlargement, separately from a CG generating device, so as to perform a cropping process on a non-input image. Furthermore, when the end portion of an image is caused to become black or the like, an image that has been subjected to texture mapping is ineffective. In addition, there is a need for an easy cropping manipulation at the time of broadcast operation.

It is desirable to appropriately process an end of an image to be texture-mapped.

The concept of the present technology is an image processing apparatus, including an image generating unit that generates a computer graphics (CG) image based on CG description data, an image mapping unit that texture-maps an image to a surface of a polygon rendered by the image generating unit, and a cropping manipulating unit that instructs whether to turn a cropping process on or off. The image mapping unit performs mapping such that an end portion of an image to be texture-mapped is not included in an output image of the image generating unit when the cropping manipulating unit instructs that the cropping process be turned on.

In the present technology, the image generating unit generates a CG image based on CG description data. The image mapping unit texture-maps an image to a surface of a polygon rendered by the image generating unit. In this case, when an instruction to turn the cropping process on is given, the image mapping unit performs mapping such that an end portion of an image to be texture-mapped is not included in an output image of the image generating unit.

For example, the image mapping unit may perform mapping such that an end portion of an image to be texture-mapped is not included in an output image of the image generating unit by enlarging the image on texture coordinates according to a cropping amount. Further, for example, the image mapping unit may generate an image of a surface aspect designated in CG description data without mapping the image on an area in which texture coordinates are within a corresponding range according to a cropping amount. Further, for example, the image mapping unit may calculate a value closer to 0 as an image is closer to an end and perform texture mapping using the value on an area in which texture coordinates are within a corresponding range according to a cropping amount.

In the present technology, when an instruction to turn the cropping process on is given, texture mapping is performed in a state in which the end portion of the image is cropped. Thus, for example, in texture mapping of an image whose portion corresponding to an end portion of a screen is distorted, the distorted portion can be prevented from being mapped.

In the present technology, for example, the image processing apparatus may further include an image selecting unit that selects a predetermined image from among a plurality of images, and a cropping option storage unit that stores information on whether or not the cropping process is to be performed on each of the plurality of images. The image mapping unit may texture-map the predetermined image selected by the image selecting unit to a surface of a polygon rendered by the image generating unit, and the image mapping unit performs mapping such that an end portion of an image to be texture-mapped is not included in an output image of the image generating unit when information representing that the cropping process is necessary on the predetermined image selected by the image selecting unit is stored in the cropping option storage unit.

In this case, mapping is performed such that an end portion of an image to be texture-mapped is not included in an output image of the image generating unit when it is determined that the cropping process is necessary on a predetermined image selected as a target of texture mapping. Thus, the cropping process can be prevented from being unnecessarily performed on an image whose portion corresponding to the end portion of a screen is not distorted.

In the present technology, for example, a table in which whether to perform the cropping process at the time of texture mapping to a surface of a polygon of a surface aspect is determined for each surface aspect (material) designated in the CG description data may be provided, and the image mapping unit may determine whether or not the cropping process is to be performed according to the table. Thus, the cropping process can be performed only when texture mapping is performed on a necessary target according to a texture mapping target.

In the present technology, for example, a cropping amount input unit that inputs a cropping amount may be further provided. Thus, the user can set the cropping amount to an arbitrary amount.

According to an embodiment of the present technology, an end of an image to be texture-mapped to a CG object surface can be appropriately processed.

### BRIEF DESCRIPTION OF THE DRAWINGS

FIG. 1 is a block diagram illustrating a configuration example of an image processing apparatus according to an embodiment of the technology;

FIG. 2 is a block diagram illustrating a concrete configuration example of an image generating unit and an image mapping unit;

FIG. 3 is a diagram illustrating a configuration example of functional blocks of an, image generating unit and an image mapping unit;

FIG. 4 is a flowchart illustrating a procedure of an image generating/rendering process of each frame/field by an image generating unit (including an image mapping unit);

FIG. 5 is a flowchart illustrating a procedure of a texture mapping process of each surface;

FIGS. 6A to 6E are diagrams for describing a cropping process of enlarging an image on texture coordinates according a cropping amount;

FIG. 7 is a diagram for describing a cropping process in which mapping is not performed on an image in an area in which texture coordinates are within a corresponding range according to a cropping amount;

FIGS. 8A to 8C are diagrams for describing a cropping process in which a value α closer to 0 is calculated as an image is closer to an end and texture mapping is performed using the value in an area in which texture coordinates are within a corresponding range according to a cropping amount;

FIG. 9 is a diagram illustrating an example of a table in which whether to perform a cropping process at the time of texture mapping to a surface of a polygon of a material is determined for each material designated in the CG description data;

FIG. 10 is a diagram for describing a case in which an image capturing target included in a texture mapping image appears only in one of a left-eye image and a right-eye image;

FIG. 11 is a diagram illustrating a left-eye image (indicated by a dotted line) and a right-eye image (indicated by a solid line) when a person at a right end is in the front; and

FIGS. 12A and 12B are diagrams for describing a cropping process on a left-eye image (indicated by a dotted line) and a right-eye image (indicated by a solid line) when a person at a right end is in the front.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of embodying the technology (hereinafter referred to as “embodiments”) will be described. The description will be given in the following order:

1. Embodiment

2. Modified Example

### 1. Embodiment

[Configuration of Image Processing Apparatus]

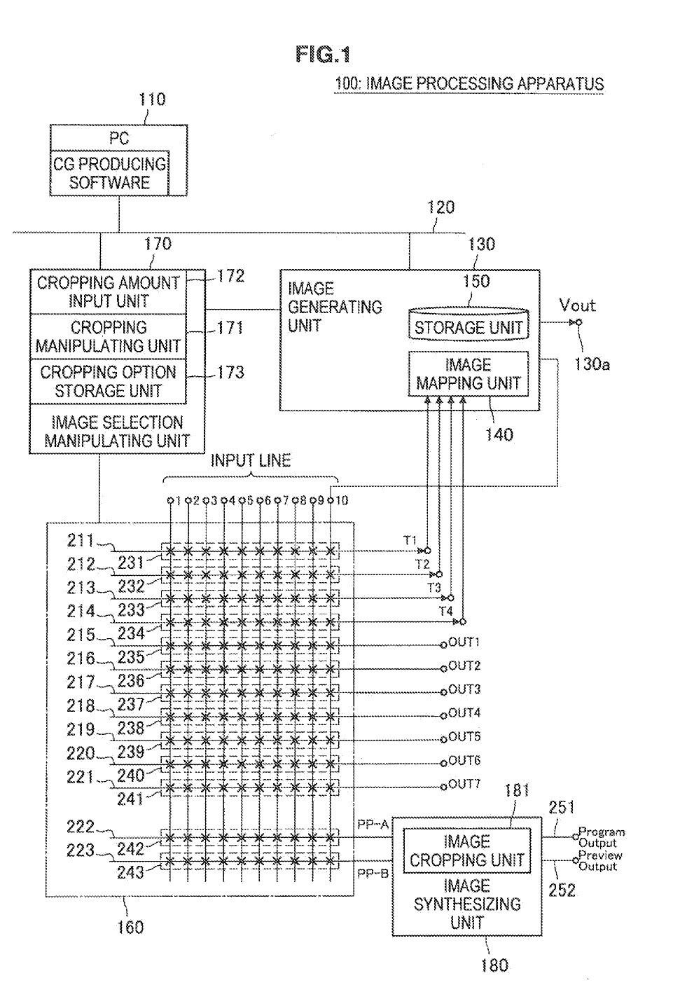

FIG. 1 illustrates a configuration example of an image processing apparatus 100 according to an embodiment of the technology. The image processing apparatus 100 includes a CG producing unit 110, a network 120, an image generating unit 130, an image mapping unit 140, and a storage unit 150. Further, the image processing apparatus 100 includes a matrix switch 160, a switcher console (image selection manipulating unit) 170, an image synthesizing unit (program/preview mixer) 180, and a derived information editing unit 190. The CG producing unit 110, the image generating unit 130 and the image selection manipulating unit 170 are connected to the network 120.

The CG producing unit 110 is configured with a personal computer (PC) including CG producing software. The CG producing unit 110 outputs CG description data of a predetermined format. For example, an exemplary format of the CG description data is Collada (registered trademark). Collada is a description definition to achieve an exchange of 3D CG data on extensible markup language (XML). For example, the following information is described in the CG description data.

(a) Definition of Material (Surface Aspect)

A definition of “material” refers to the quality of the surface of a CG object (how it looks). The definition of the material contains information on color, reflection method, light emission, unevenness or the like. The definition of the material may contain information on texture mapping. As described above, texture mapping is a technique to paste an image to a CG object, and a complex shape can be expressed while relatively reducing a load of a processing system.

(b) Definition of Geometric Information “Geometry”

A definition of geometric information “Geometry” contains information on position coordinates and vertex coordinates about a polygon mesh.

(c) Definition of Camera

A definition of “camera” contains parameters of a camera.

(d) Definition of Animation

A definition of “animation” contains various information in each key frame of an animation. For example, the definition of the animation contains information on time In each key frame of the animation. The various information refers to information such as a time of a key frame point of a corresponding object (node), position and vertex coordinate values, the size, a tangent vector, an interpolation method, and a change in various information in an animation.

(e) Position, Direction, Size, Definition of Corresponding Geometric Information, and Definition of Corresponding Material of Node (Object) in Scene

These kinds of information are not dispersive but are associated with one another, for example, as follows:
Node . . . geometric information
Node . . . materials (plural)
Geometric information . . . polygon sets (plural)
Polygon set . . . material (one of materials corresponding to node)
Animation . . . node

A description configuring a single screen is called a scene. Each definition is called a library and is referred to by a scene. For example, when there are two rectangular parallelepiped objects, each rectangular parallelepiped object is described as one node, and one of the material definitions is associated with one node. As a result, the material definition is associated with each rectangular parallelepiped object, and rendering is performed based on color or reflection characteristics according to each material definition.

Alternatively, when the rectangular parallelepiped object is described by a plurality of polygon sets and the polygon sets are associated with the material definitions, different polygon sets are rendered by different material definitions. For example, although the rectangular parallelepiped object has six sides, the rectangular parallelepiped object may be described by three polygon sets such that three sides are described by one polygon set, one side is described by one polygon set, and two sides are described by one polygon set. Since different polygon sets are associated with different material definitions, different sides can be rendered in different colors.

When texture mapping is designated in the material definition, an image based on image data is texture-mapped to an associated side of the object.

For example, a setting may be made so that an image can be texture-mapped to the material definition. Thus, the same image can be texture-mapped to all sides of the rectangular parallelepiped object, and different images can be texture-mapped to different sides.

The matrix switch 160 selectively extracts a predetermined image (image data) from among a plurality of input images (input image data). In this embodiment, the matrix switch 160 includes 10 input lines, 13 output bus lines 211 to 223, and 13 cross point switch groups 231 to 243. The matrix switch 160 configures a part of an effect switcher. The matrix switch 160 is used to supply the image mapping unit 140 as an external device with image data and to supply the internal image synthesizing unit 180 or the like with image data.

The output bus lines 211 to 214 are bus lines for supplying the image mapping unit 140 with image data. The output bus lines 215 to 221 are bus lines for outputting image data to the outside. The output bus lines 222 and 223 are bus lines for supplying the internal image synthesizing unit 180 with image data.

The 10 input lines are arranged in one direction (a vertical direction in FIG. 1). Image data is input to the input lines “1” to “9” from a video tape recorder (VTR), a video camera, or the like. CG image data output from the image generating unit 130 is input to the input line “10.” The 13 output bus lines 211 to 223 intersect the input lines and are arranged in another direction (a horizontal direction in FIG. 1).

The cross point switch groups 231 to 234 perform connection operations at cross points at which the 10 input lines intersect the output bus lines 211 to 214, respectively. Based on the user's image selection manipulation, connection operations of the cross point switch groups 231 to 234 are controlled, and any of image data input to the 10 input lines is selectively output to the output bus lines 211 to 214. The output bus lines 211 to 214 configure output lines T1 to T4 that output image data for texture mapping (mapping input).

The cross point switch groups 235 to 241 perform connection operations at cross points at which the 10 input lines intersect the output bus lines 215 to 221, respectively. Based on the user's image selection manipulation, the cross point switch groups 235 to 241 are controlled, and any of image data input to the 10 input lines is selectively output to the output bus lines 215 to 221. The output bus lines 215 to 221 configure output lines OUT1 to OUT7 that output image data for external output.

The cross point switch groups 242 and 243 perform connection operations at cross points at which the 10 input lines intersect the output bus lines 222 and 223, respectively. Based on the user's image selection manipulation, the cross point switch groups 242 and 243 are controlled, and any of image data input to the 10 input lines is selectively output to the output bus lines 222 and 223.

An on/off operation of the cross point switches of the cross point switch groups 231 to 243 causes image data including consecutive frame data to be switched and thus is performed within a vertical blanking interval (VBI), which is an interval between frames.

Image data output to the output bus lines 222 and 223 is input to the image synthesizing unit (program/preview mixer) 180. The image synthesizing unit 180 performs a process of synthesizing image data input from the output bus lines 222 and 223. A program (PGM) output is output to the outside from the image synthesizing unit 180 via a program output line 251. A preview output is output to the outside from the image synthesizing unit 180 via a preview output line 252.

The image synthesizing unit 180 includes an image cropping unit 181 therein. The image cropping unit 181 performs a cropping process of cutting off an end (edge) of an image when image data output to the output bus lines 222 and 223 includes an image that is distorted in an end portion of a screen. The cropping process on image data (mapping input) T1 to T4 for texture mapping is performed in the image mapping unit 140 as will be described later.

The image selection manipulating unit 170 receives a manipulation input of an instruction to the matrix switch 160. The image selection manipulating unit 170 is provided with a console (not shown) including a push button array for manipulating on/off operations of switches of the cross point switch groups of the matrix switch 160.

The image selection manipulating unit 170 includes a cropping manipulating unit 171, a cropping amount input unit 172, and a cropping option storage unit 173. The cropping manipulating unit 171 is a manipulating unit through which the user instructs the image mapping unit 140 to turn the cropping process on/off.

The cropping amount input unit 172 is an input unit through which the user inputs a cropping amount. In this case, the user inputs information on whether an end of an image to be cropped is either or both of an end in a horizontal direction and an end in a vertical direction. For example, a percentage value is input as the cropping amount. The cropping amount input unit 172 is an optional component. When the image mapping unit 140 uses a fixed amount as the cropping amount, the cropping amount input unit 172 may not be provided.

The cropping option storage unit 173 stores information on whether or not the cropping process needs to be performed on each of a plurality of input images (input image data). That is, as described above, image data from a video tape recorder (VTR), a video camera, or the like is input to each of input lines “1” to “9” of the matrix, switch 160. The cropping option storage unit 173 stores information on whether or not the cropping process needs to be performed on image data input to each input line.

The image generating unit 130 generates a CG image which is a 3D space image based on CG description data created by the CG producing unit 110. The storage unit 150 stores the CG description data. When the CG description data is read in, the image generating unit 130 holds information such as each definition in a memory and holds a correspondence between the definitions as a data structure. The image generating unit 130 holds various values in a key frame for executing an animation in a memory.

For example, the image generating unit 130 performs rendering on a polygon set present in geometric information of a certain node by designating a color of the polygon set and the like with reference to the geometric information and the associated material definition. In the case of an animation, rendering is performed such that a current time progresses in units of frames, and a value of a previous key frame and a value of a next key frame are decided by performing an interpolation between the values.

For example, the image generating unit 130 controls the image mapping unit 140 such that an image based on a mapping input forming a pair with each attribute value (name) present in an image allocation table (not shown) is texture-mapped to the surface of a polygon (polygon set) associated with the attribute value (name). The image mapping unit 140 performs texture mapping under control of the image generating unit 130. For example, an attribute is a material, and, for example, an image allocation table is a table in which a material name is associated with an image input number (a number designating one of T1 to T4 in FIG. 1).

Mapping inputs T1 to T4 which are image data for texture mapping are supplied from the matrix switch 160 to the image mapping unit 140 as described above. The image mapping unit 140 texture-maps an image based on a mapping input forming a pair with each attribute value (name) present in an image allocation table to the surface of a polygon (polygon set) associated with the attribute value (name) under control of the image generating unit 130.

For example, the image mapping unit 140 may be mounted to be integrated with the image generating unit 130 and may be implemented by control by software on a central processing unit (CPU) and an operation by hardware such as a graphics processing unit (GPU). The control software designates a polygon set to be texture-mapped and instructs the designated polygon set to the hardware.

[Configuration Example of Image Generating Unit and Image Mapping Unit]

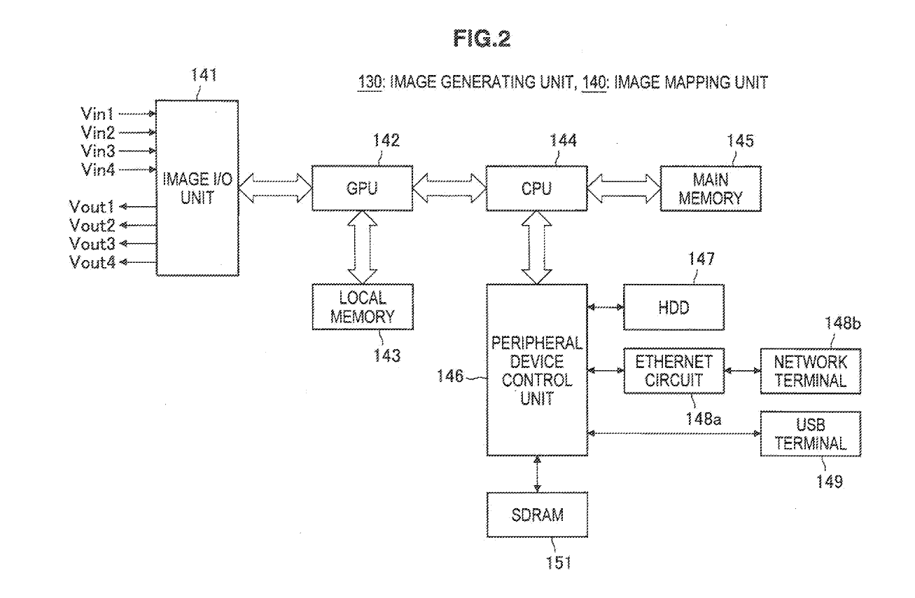

FIG. 2 illustrates a concrete configuration example of the image generating unit 130 and the image mapping unit 140. The image generating unit 130 and the image mapping unit 140 include an image input/output (I/O) unit 141, a GPU 142, a local memory 143, a CPU 144, and a main memory 145. The image generating unit 130 and the image mapping unit 140 further include a peripheral device control unit 146, a hard disk drive (HDD) 147, an Ethernet circuit 148a, and a network terminal 148b. The image generating unit 130 and the image mapping unit 140 further include a universal serial bus (USB) terminal 149 and a synchronous dynamic random access memory (SDRAM) 151. Here, “Ethernet” is a registered trademark.

The image I/O unit 141 receives image data to be texture-mapped, and outputs image data of a CG image to which an image based on the image data is appropriately texture-mapped. The image I/O unit 141 can receive image data of a maximum of four systems and can also output image data of a maximum of four systems. For example, image data handled here may be image data conforming to a high definition television-serial digital interface (HD-SDI) standard specified in SMPTE292M. The GPU 142 and the main memory 145 are configured to be able to equally access the image I/O unit 141.

The main memory 145 functions as a working area of the CPU 144 and temporarily stores image data input from the image I/O unit 141. The CPU 144 entirely controls the image generating unit 130 and the image mapping unit 140. The CPU 144 is connected with the peripheral device control unit 146. The peripheral device control unit 146 performs an interface process between the CPU 144 and a peripheral device.

The CPU 144 is connected with a built-in HDD 147 via the peripheral device control unit 146. Further, the CPU 144 is connected with the network terminal 148b via the peripheral device control unit 146 and the Ethernet circuit 148a. The CPU 144 is connected with the USB terminal 149 via the peripheral device control unit 146. Furthermore, the CPU 144 is connected to the SDRAM 151 via the peripheral device control unit 146.

The CPU 144 controls texture coordinates. In other words, the CPU 144 performs a process of texture-mapping an image based on input image data to the surface of a polygon to be rendered by the GPU 142 on the input image data. The GPU 142 generates a CG image based on CG description data stored in the HDD 147 or the like, and texture-maps an image to the surface of a designated polygon as necessary. The local memory 143 functions as a working area of the GPU 142 and temporarily stores image data of the CG image created by the GPU 142.

The CPU 144 can access the local memory 143 as well as the main memory 145. Likewise, the GPU 142 can access the local memory 143 and the main memory 145. The CG image data, which has been generated by the GPU 142 and then primarily stored in the local memory 143, is sequentially read from the local memory 143 and output from the image I/O unit 141.

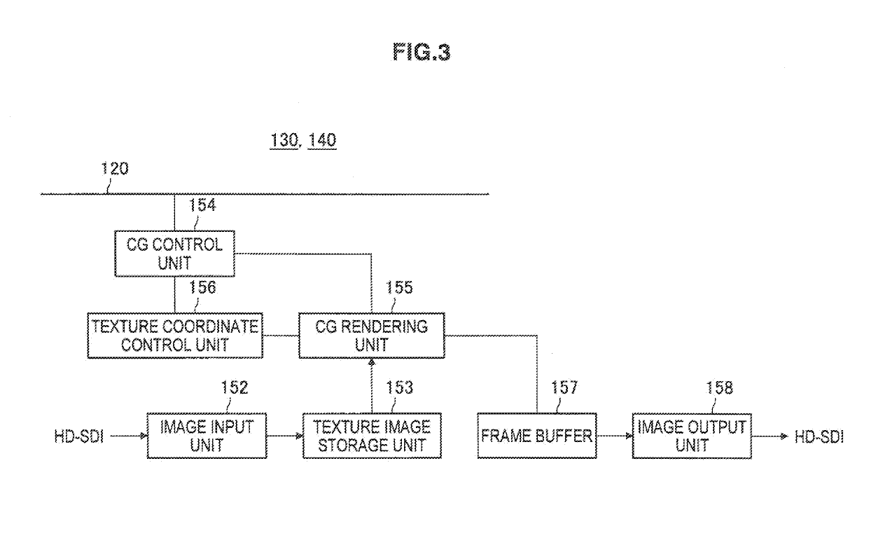

FIG. 3 illustrates, a configuration example of functional blocks of the image generating unit 130 and the image mapping unit 140. The image generating unit 130 and the image mapping unit 140 include functional blocks such as an image input unit 152, a texture image storage unit 153, a CG control unit 154, a CG rendering unit 155, a texture coordinate control unit 156, a frame buffer 157, and an image output unit 158.

The image input unit 152 and the image output unit 158 are implemented by the image I/O unit 141. The texture image storage unit 153 is implemented by the main memory 145. The CG control unit 154 and the texture coordinate control unit 156 are implemented by the CPU 144. The CG rendering unit 155 is implemented by the GPU 142. The frame buffer 157 is implemented by the local memory 143.

The image input unit 152 and the texture image storage unit 153 form a pair. The number of image input systems can be increased by increasing the number of pairs of the image input unit 152 and the texture image storage unit 153. The frame buffer 157 and the image output unit 158 form a pair. The number of image output systems can be increased by increasing the number of pairs of the frame buffer 157 and the image output unit 158.

[Cropping Process of Image Mapping Unit]

The cropping process of the image mapping unit 140 will be described. When an instruction to turn the cropping process on is given by the cropping manipulating unit 171 of the image selection manipulating unit 170, the image mapping unit 140 performs the cropping process. In other words, the image mapping unit 140 performs mapping such that the end (edge) portion of an image to be texture-mapped is not included in an output image of the image generating unit 130.

A flowchart of FIG. 4 illustrates a procedure of an image generating/rendering, process of each frame/field by the image generating unit 130 (including the image mapping unit 140). In step ST1, the image generating unit 130 starts the process, and thereafter, the process proceeds to step ST2.

In step ST2, the image generating unit 130 performs a rendering process based on CG description data. Then, in step ST3, the image generating unit 130 determines whether or not the CG description data includes a texture mapping instruction. When it is determined the CG description data includes a texture mapping instruction, in step ST4, the image generating unit 130 performs a mapping process for each surface (the surface of a polygon) which is to be subjected to texture mapping.

After the process of step ST4, in step ST5, the image generating unit 130 ends the process. Meanwhile, when it is determined in step ST3 that the CG description data does not include a texture mapping instruction, in step ST5, the process ends immediately.

A flowchart of. FIG. 5 illustrates a procedure of a mapping process of each surface in step ST4 of the flowchart of FIG. 4. In step ST41, the image generating unit 130 starts the process, and thereafter, the process proceeds to step ST42. In step ST42, the image generating unit 130 determines whether or not an image to be mapped is a target of the cropping process based on information stored in the cropping option storage unit 173.

When it is determined that the image to be mapped is a target of the cropping process, in step ST43, the image generating unit 130 perform mapping while performing the cropping process according to the cropping amount. After the process of step ST43, in step ST44, the image generating unit 130 ends the process. However, when it is determined in step ST42 that the image to be mapped is not a target of the cropping process, in step ST45, the image generating unit 130 performs mapping without performing the cropping process. After the process of step ST45, in step ST44, the image generating unit 130 ends the process.

[Concrete Examples of Cropping Process]

Next, examples of the cropping process performed by the image mapping unit 140 will be described.

### Process Example 1

The image mapping unit 140 performs mapping such that the end portion of an image to be texture-mapped is not included in an output image of the image generating unit 130 by enlarging an image on the texture coordinates according to the cropping amount.

In this case, the image mapping unit 140 manipulates the texture coordinates for the end of the image not to be mapped. Both texture coordinates U and V are in a range between 0 and 1. By fully mapping this range to an object surface, an overall area of x and y of an image is displayed. On the other hand, when it is desired to enlarge an image, a range smaller than U and V, for example, a range between 0.1 and 0.9 in the case of 10% cropping, is mapped to an object surface, and thus an image is consequently enlarged.

On the premise that [a,b] represents, the range, (u1,v1) represents non-converted coordinates, and (u2,v2) represents converted coordinates, conversion equations of the texture coordinates are expressed by the following Formulas 1 and 2:

u2=(b−a)×u1+a (1)

v2=(b−a)×v1+a (2)

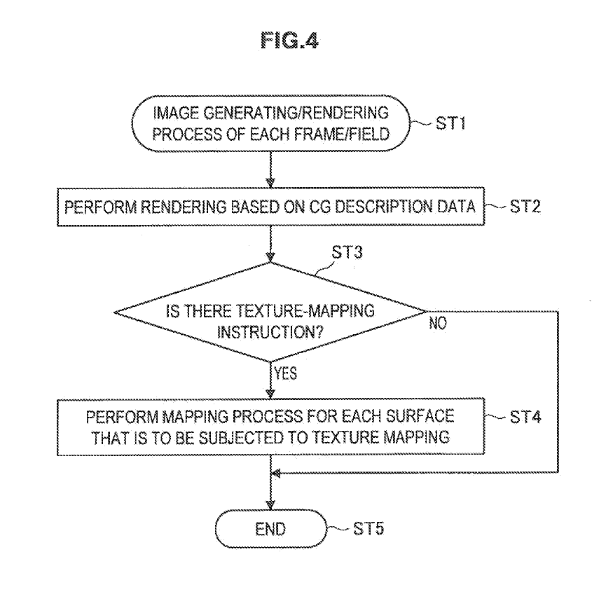

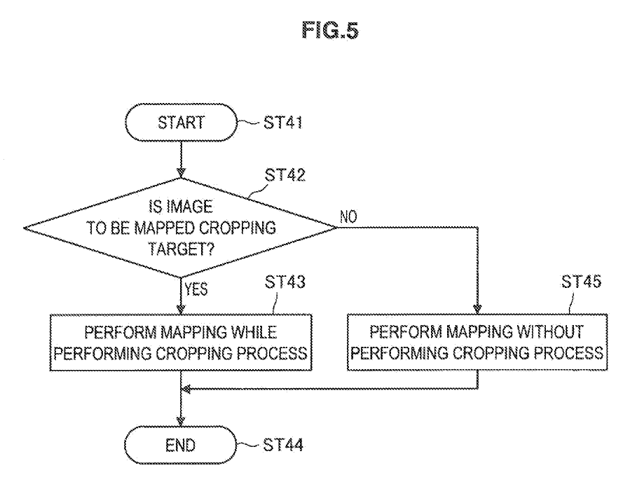

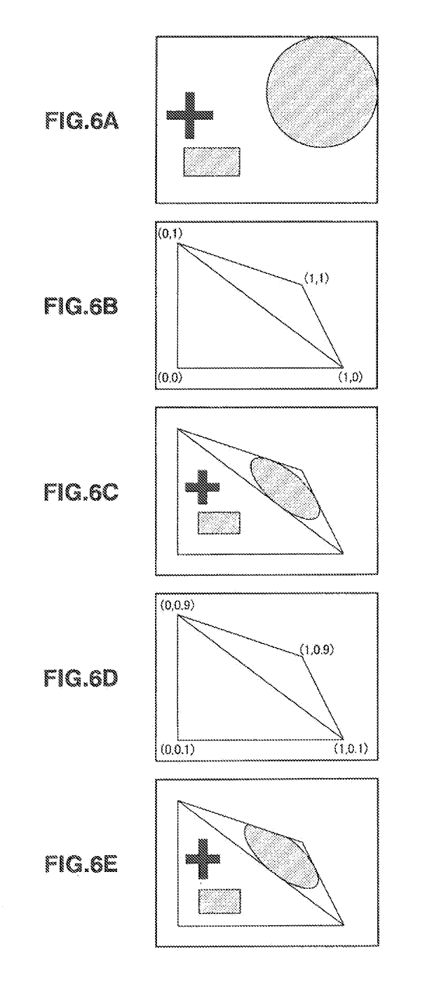

For example, let us consider an image to be texture-mapped illustrated in FIG. 6A, a polygon to be texture-mapped illustrated in FIG. 6B, and texture coordinates (UV coordinates). FIG. 6C illustrates a texture mapping result (how an output image is seen) when the cropping process is not performed.

FIG. 6D illustrates converted texture coordinates (UV coordinates) when 10% cropping is vertically performed, and FIG. 6E illustrates a texture mapping result (how an output image is seen) when the cropping process is performed. As described above, an image is enlarged in a vertical direction by the cropping process, and thus the end portion of the image is not mapped.

### Processing Example 2

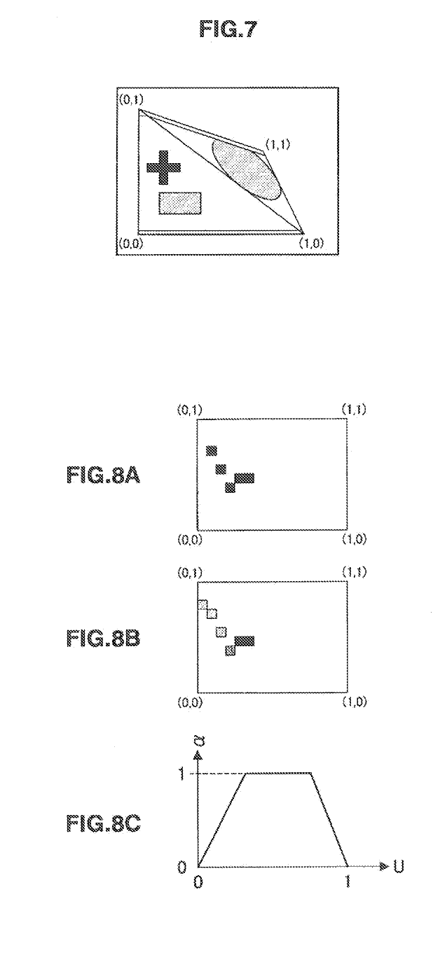

The image mapping unit 140 generates an image according to a surface aspect (material) designated in CG description data without mapping an image on an area whose texture coordinates are within a corresponding range according to the cropping amount. In other words, for example, the image mapping unit 140 does not perform texture mapping on an area whose texture coordinate V is in a range from 0 to 0.1 or in a range from 0.9 to 1 in the case of 10% vertical cropping when texture mapping is performed. For example, let us consider an image to be texture-mapped illustrated, in FIG. 6A, a polygon to be texture-mapped illustrated in FIG. 6B, and texture coordinates (UV coordinates). FIG. 7 illustrates a texture mapping result (how an output image is seen) when 10% cropping is vertically performed. As can be easily seen from FIG. 7, a line representing a cropping position is added.

### Processing Example 3

The image mapping unit 140 calculates a value (α) closer to 0 as an image area is closer, to the end, and performs texture mapping using the value on an area in which the texture coordinates are within a corresponding range according to the cropping amount. In other words, for example, the image mapping unit 140 calculates the value α as illustrated in FIG. 8C in the case of 30% horizontal cropping. In this case, the value α is set to 1 in an area whose texture coordinate U is in a range from 0.3 to 0.7. Further, the value α linearly changes in an area in which the value α is 0 when U is 0, the value α is 0 when U is 1, and U is in a range from 0 to 0.3 and in a range from 0.7 to 1.

The image mapping unit 140 blends an image with an original surface aspect using the value α as a blending rate. FIG. 8A illustrates a texture mapping result (how an output image is seen) when the cropping process is not performed. FIG. 8B illustrates a texture mapping result (how an output image is seen) when the cropping process is performed. In this case, the end of the image is gradually changed from an image to be mapped to an original surface aspect.

An operation example by the image processing apparatus 100 illustrated in FIG. 1 will be described. The CG producing unit 110 generates CG description data for generating a predetermined CG image through CG producing software. The CG description data generated by the CG producing unit 110 is transmitted to the image generating unit 130 via the network 120 and then stored in the storage unit 150.

The image generating unit 130 generates a CG image which is a 3D space image based on CG description data created by the CG producing unit 110. For example, the image generating unit 130 controls the image mapping unit 140 such that an image based on a mapping input forming a pair with each attribute value (name) present in an image allocation table (not shown) is texture-mapped to the surface of a polygon (polygon set) associated with the attribute value (name).

The image mapping unit 140 performs texture mapping under control of the image generating unit 130. That is, the image mapping unit 140 texture-maps an image based on a mapping input forming a pair with each attribute value (name) present in an image allocation table to the surface of a polygon (polygon set) associated with the attribute value (name).

At this time, when an instruction to turn the cropping process on is given by the cropping manipulating unit 171 of the image selection manipulating unit 170, the image mapping unit 140 performs the cropping processes such as “Processing Example 1” to “Processing Example 3”. In this case, the image mapping unit 140 performs mapping such that the end (edge) portion of an image to be texture-mapped is not included in an output image of the image generating unit 130.

Then, image data Vout of a CG image obtained by texture-mapping an image to the surface of a predetermined polygon is output to an output terminal 130a led from the image generating unit 130. Further, the image data of the CG image, which is obtained by texture-mapping the image to the surface of a predetermined polygon, output from the image generating unit 130 is input to the input line “10” of the matrix switch 160.

In the image processing apparatus 100 illustrated in FIG. 1, when an instruction to turn the cropping process on is given by the cropping manipulating unit 171 of the image selection manipulating unit 170, the image mapping unit 140 of the image generating unit 130 performs texture mapping in a state in which an end portion of an image is cropped. Thus, for example, a distorted portion, can be prevented from being mapped at the time of texture mapping of an image whose portion corresponding to the end portion of a screen is distorted.

Further, in the image processing apparatus 100 illustrated in FIG. 1, the image mapping unit 140 performs the cropping process when it is determined that an image of a texture mapping target needs to be subjected to the cropping process based on the information stored in the cropping option storage unit 173. Thus, the cropping process can be prevented from being unnecessarily performed on an image whose portion corresponding to the end portion of a screen is not distorted. Further, when it is determined that an image which is not processed by the image generating unit 130 but input to the image synthesizing unit 180 needs to be cropped based on the information stored in the cropping option storage unit 173, the image cropping unit 181 performs the cropping process.

### 2. Modified Example

In the above embodiment, the image mapping unit 140 determines whether or not the cropping process needs to be performed based on the information stored in the cropping option storage unit 173, that is, depending on an image. However, it may be determined whether or not the cropping process needs to be performed depending on the surface aspect (material) designated in CG description data.

In this case, a table in which whether to perform the cropping process when texture mapping is performed on the surface of a polygon of the surface aspect is determined in advance for each surface aspect (material) designated in CG description data is provided. For example, the table is arranged in the image selection manipulating unit 170 or the image generating unit 130. In this case, the image mapping unit 140 determines whether or not the cropping process is necessary according to the table.

In many cases, it is determined whether or not the cropping process is to be performed depending on a feature of an image to be texture-mapped. However, there is also a case in which it is appropriate to determine whether or not the cropping process is to be performed according to another reason. For example, when an image of an announcer which is being captured by a camera in a studio is put onto the surface of a box in a CG virtual space, the cropping process is preferably performed such that the strange-looking end portion is not included and viewers' attention is not drawn to it.

On the other hand, when a moving image is texture-mapped to the surface of the floor as a simple moving pattern, it may be desirable not to perform the cropping process since attention is not drawn to image content. Thus, when a material of CG description data is designated as a texture mapping target, information on whether or not the cropping process is to be performed is stored in the table as a material attribute.

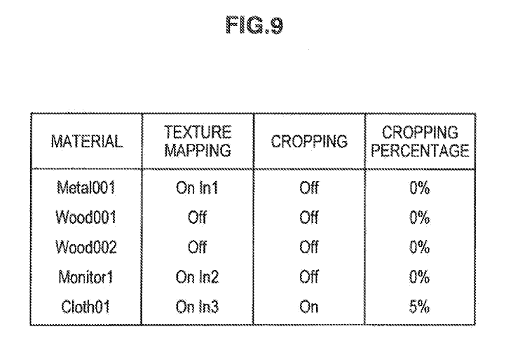

FIG. 9 illustrates an example of a table in which whether to perform the cropping process when texture mapping is performed on the surface of a polygon of the material is determined for each material designated in CG description data. In the example of this table, for example, the cropping process is not performed on materials “Meta1001” and “Monitor1,” however, the cropping process is performed on a material “Cloth01.” Further, a cropping percentage is stored in the table as the cropping amount.

According to the above embodiment, when information on whether or not cropping is necessary is stored for each image, the cropping process is performed, for example, only when a selected image needs to be cropped and the cropping process is set to be performed (On) on a target material. In some uses, when the selected image needs to be cropped, the cropping process may be executed regardless of on/off setting of the cropping process of the material. For example, in order to use old images, it is desirable that the cropping process be necessarily performed on the old images.

Although not described above, a target image of texture mapping may include a left-eye image and a right-eye image configuring a stereoscopic image. In this case, when texture mapping is performed on the stereoscopic image, by capturing a left-eye image and a right-eye image of a texture mapping image through a left-eye virtual camera and a right-eye virtual camera and performing the rendering process on the left-eye image and the right-eye image, a stereoscopic effect of the texture mapping image can be maintained.

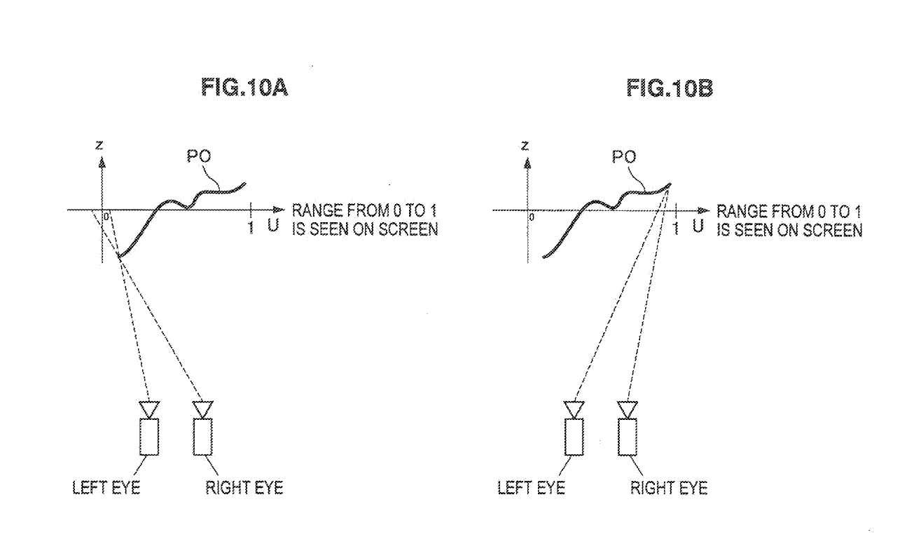

However, an image capturing target included in the texture mapping image may appear only in one of the left-eye image and the right-eye image. For example, as illustrated in FIG. 10A, a left end of a stereoscopic object PO seen in the front does not appear in the right-eye image. On the other hand, as illustrated in FIG. 10B, a right end of the stereoscopic object PO positioned in the rear appears in both the left-eye image and the right-eye image. As described above, when an image capturing target included in the texture mapping image appears in only one of the left-eye image and the right-eye image, an uncomfortable feeling can be reduced by performing texture mapping, for example, using the value α.

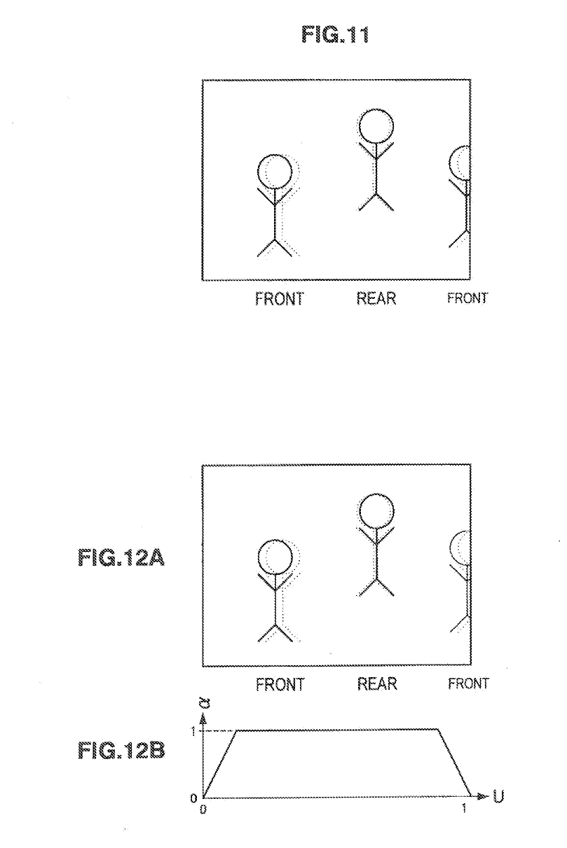

For example, FIG. 11 illustrates a left-eye image (indicated by a dotted line) and a-right-eyeimage (indicated by a solid line) when a person at a right end is in the. front. In this case, for example, as illustrated in FIG. 12B, the value α may be calculated, and the cropping process may be performed using the value α. In this case, as illustrated in FIG. 12A, the cropping process is performed on a portion of the person at the right end. That is, since the portion of the person at the right end gradually fades by the cropping process using the value α, the portion becomes less prominent, and thus an uncomfortable feeling can be reduced.

When a target image of texture mapping includes a left-eye image and a right-eye image configuring a stereoscopic image, the image mapping unit 140 determines whether or not the end of an image is a portion seen in the front or a portion present in the rear by analyzing the images or using depth information (parallax information) attached to the images. Then, when the end of the image is the portion seen in the front, the image mapping unit 140 performs the cropping process, and thus an uncomfortable feeling can be reduced as described above.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing apparatus, including

an image generating unit that generates a computer graphics (CG) image based on CG description data;

an image mapping unit that texture-maps an image to a surface of a polygon rendered by the image generating unit; and

a cropping manipulating unit that instructs whether to turn a cropping process on or off,

wherein the image mapping unit performs mapping such that an end portion of an image to be texture-mapped is not included in an output image of the image generating unit when the cropping manipulating unit instructs that the cropping process be turned on.

(2)

The image processing apparatus according to (1), further including

an image selecting unit that selects a predetermined image from among a plurality of images; and

a cropping option storage unit that stores information on whether or not the cropping process is to be performed on each of the plurality of images,

wherein the image mapping unit texture-maps the predetermined image selected by the image selecting unit to a surface of a polygon rendered by the image generating unit, and

the image mapping unit performs mapping such that an end portion of an image to be texture-mapped is not included in an output image of the image generating unit when information representing that the cropping process is necessary on the predetermined image selected by the image selecting unit is stored in the cropping option storage unit.

(3)

The image processing apparatus according to (1) or (2), further comprising

a table in which whether to perform the cropping process at the time of texture mapping to a surface of a polygon of a surface aspect is determined for each surface aspect designated in the CG description data,

wherein the image mapping unit determines whether or not the cropping process is to be performed according to the table.

(4)

The image processing apparatus according to any one of (1) to (3), wherein the image mapping unit performs mapping such that an end portion of an image to be texture-mapped is not included in an output image of the image generating unit by enlarging the image on texture coordinates according to a cropping amount.

(5)

The image processing apparatus according to any one of (1) to (3), wherein the image mapping unit generates an image of a surface aspect designated in the CG description data without mapping the image on an area in which texture coordinates are within a corresponding range according to a cropping amount.

(6)

The image processing apparatus according to any one of (1) to (3), wherein the image mapping unit calculates a value closer to 0 as an image is closer to an end and performs texture mapping using the value on an area in which texture coordinates are within a corresponding range according to a cropping amount.

(7)

The image processing apparatus according to any one of (1) to (6), further comprising a cropping amount input unit that inputs a cropping amount.

The present application contains subject matter related to that disclosed in Japanese Priority Patent Application JP 2011-084435 filed in the Japan Patent Office on Apr. 6, 2011, the entire content of which is hereby incorporated by reference.

What is claimed is:

1. An image processing apparatus, comprising:
an image generating unit that generates a computer graphics (CG) image based on CG description data;
an image mapping unit that texture-maps an image to a surface of a polygon rendered by the image generating unit; and
a cropping manipulating unit that instructs whether to turn a cropping process on or off,
wherein the image mapping unit performs mapping such that an end portion of an image to be texture-mapped is not included in an output image of the image generating unit when the cropping manipulating unit instructs that the cropping process be turned on.

2. The image processing apparatus according to claim 1, further comprising:
an image selecting unit that selects a predetermined image from among a plurality of images; and
a cropping option storage unit that stores information on whether or not the cropping process is to be performed on each of the plurality of images,
wherein the image mapping unit texture-maps the predetermined image selected by the image selecting unit to a surface of a polygon rendered by the image generating unit, and
the image mapping unit performs mapping such that an end portion of an image to be texture-mapped is not included in an output image of the image generating unit when information representing that the cropping process is necessary on the predetermined image selected by the image selecting unit is stored in the cropping option storage unit.

3. The image processing apparatus according to claim 1, further comprising
a table in which whether to perform the cropping process at the time of texture mapping to a surface of a polygon of a surface aspect is determined for each surface aspect designated in the CG description data,
wherein the image mapping unit determines whether or not the cropping process is to be performed according to the table.

4. The image processing apparatus according to claim 1, wherein the image mapping unit performs mapping such that an end portion of an image to be texture-mapped is not included in an output image of the image generating unit by enlarging the image on texture coordinates according to a cropping amount.

5. The image processing apparatus according to claim 1, wherein the image mapping unit generates an image of a surface aspect designated in the CG description data without mapping the image on an area in which texture coordinates are within a corresponding range according to a cropping amount.

6. The image processing apparatus according to claim 1, wherein the image mapping unit calculates a value closer to 0 as an image is closer to an end and performs texture mapping using the value on an area in which texture coordinates are within a corresponding range according to a cropping amount.

7. The image processing apparatus according to claim 1, further comprising a cropping amount input unit that inputs a cropping amount.

8. The image processing apparatus according to claim 1, wherein the image includes a left-eye image and a right-eye image configuring a stereoscopic image, and
the image mapping unit performs the cropping process when it is determined that a stereoscopic image object is seen in a front at a left or right end due to a parallax between the left-eye image and the right-eye image.

9. A method of processing an image, comprising:
generating a computer graphics (CG) image based on CG description data; and
texture mapping an image to a surface of a polygon rendered in the generating of the CG image;
wherein the texture mapping of the image is performed such that an end portion of an image to be texture-mapped is not included in an output image when an instruction to turn a cropping process on is given.

10. A program causing a computer to function as:
an image generating unit that generates a computer graphics (CG) image based on CG description data; and
an image mapping unit that texture-maps an image to a surface of a polygon rendered by the image generating unit;
wherein the image mapping unit performs mapping such that an end portion of an image to be texture-mapped is not included in an output image of the image generating unit when an instruction to turn a cropping process on is given.
